(19) United States
(12) Patent Application Publication
(10) Pub. No.: US 2025/0021277 A1
(43) Pub. Date: Jan. 16, 2025

(54) INFORMATION PROCESSING SYSTEM AND NON-TRANSITORY COMPUTER READABLE PROGRAM

(71) Applicant: FUJIFILM BUSINESS INNOVATION CORP., Tokyo (JP)

(72) Inventor: Asae ORIMOTO, Kanagawa (JP)

(73) Assignee: FUJIFILM BUSINESS INNOVATION CORP., Tokyo (JP)

(21) Appl. No.: 18/589,821

(22) Filed: Feb. 28, 2024

(30) Foreign Application Priority Data
Jul. 12, 2023 (JP) 2023-114279

(51) Int. Cl. G06F 3/12

(52) U.S. Cl. CPC G06F 3/1239; G06F 3/1207; G06F 3/1238; G06F 3/1268; G06F 3/1285

(57) ABSTRACT

An information processing apparatus includes one or more processors configured to: when a request for execution of a job is made to the information processing apparatus by a remote operation from a remote terminal of a first user, in a case where a direct operation is being performed by a second user with respect to the information processing apparatus, inquire of the second user whether to permit the execution of the job; and cause the job to be executed in a case where the execution of the job is permitted as a response to the inquiry.

### CROSS-REFERENCE TO RELATED APPLICATIONS

This application is based on and claims priority under 35 USC 119 from Japanese Patent Application No. 2023-114279 filed Jul. 12, 2023.

### BACKGROUND

### (i) Technical Field

The present disclosure relates to an information processing system and a non-transitory computer readable medium.

### (ii) Related Art

A technique is known by which a remote terminal is connected to an information processing apparatus, such as a so-called multifunction peripheral capable of printing, reading, and the like of a document, so that the operation screen of the information processing apparatus can be remotely operated from the remote terminal (see, for example, Japanese Patent No. 6071273). The technique enables a remote operation from the remote terminal and a direct operation on the operation screen of the information processing apparatus.

### SUMMARY

However, when a direct operation is being performed on the operation screen or the like of the information processing apparatus, the remote operation may be restricted in order to prevent interference between the direct operation and the remote operation. In this case, even when the contents of the direct operation and the contents of the remote operation do not interfere with each other, the remote operation may be unconditionally restricted, preventing efficient utilization of the information processing apparatus.

Aspects of non-limiting exemplary embodiments of the present disclosure relate to achieving more efficient utilization of an information processing apparatus than when a remote operation is unconditionally restricted, while suppressing interference between a direct operation and a remote operation with respect to the information processing apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including one or more processors configured to: when a request for execution of a job is made to the information processing apparatus by a remote operation from a remote terminal of a first user, in a case where a direct operation is being performed by a second user with respect to the information processing apparatus, inquire of the second user whether to permit the execution of the job; and cause the job to be executed in a case where the execution of the job is permitted as a response to the inquiry.

### BRIEF DESCRIPTION OF THE DRAWINGS

Exemplary embodiments of the present disclosure will be described in detail based on the following figures, wherein:

FIG. 1 is a diagram of an example of an overall configuration of an information processing system to which a first exemplary embodiment is applied;

FIG. 2 is a diagram of an example of a hardware configuration of an image processing apparatus;

FIG. 3 is a diagram of an example of a functional configuration of a control unit of the image processing apparatus;

FIG. 4 is a diagram of an example of a functional configuration of a control unit of a user terminal;

FIG. 5 is a flowchart illustrating the flow of a process in the image processing apparatus;

FIG. 6 is a diagram illustrating the flow of the states of the image processing apparatus and the user terminal;

FIG. 7 is a flowchart illustrating the flow of a process in the image processing apparatus according to a second exemplary embodiment; and

FIG. 8 is a diagram illustrating the flow of the states of the image processing apparatus and the user terminal.

### DETAILED DESCRIPTION

In the following, exemplary embodiments of the present disclosure will be described in detail with reference to the accompanying drawings.

### First Exemplary Embodiment

### Configuration of Information Processing System

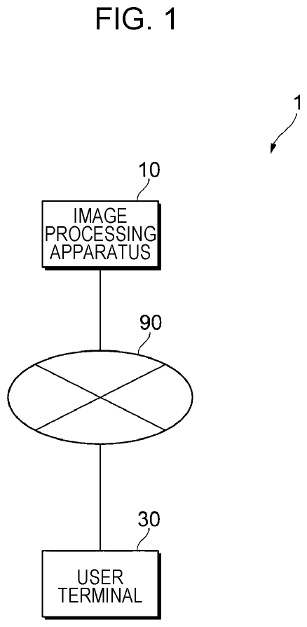

FIG. 1 is a diagram of an example of an overall configuration of an information processing system 1 to which a first exemplary embodiment is applied.

The information processing system 1 is composed of an image processing apparatus 10 and a user terminal 30 that are connected to each other via a network 90. The network 90 is, for example, a local area network (LAN) or the Internet.

### Image Processing Apparatus

The image processing apparatus 10 is an information processing apparatus that performs various processes in response to an input operation performed by a user who utilizes the information processing system 1. For example, the image processing apparatus 10 performs a process for forming an image on a medium such as a sheet, a process for outputting a recording medium on which an image has been formed, and a process for reading an image formed on a sheet or the like. Examples of the image processing apparatus 10 include a so-called electrophotographic multifunction peripheral that forms a toner image on a printing surface of a sheet, and a so-called inkjet printer that ejects ink onto a printing surface of a sheet.

The image processing apparatus 10 displays a user interface, receives an input operation with respect to the user interface, and acquires the input information thereof. The input operation with respect to the user interface is divided into a direct operation and a remote operation. The direct operation is a direct input operation that is performed with respect to the user interface displayed on the image processing apparatus 10, by a user facing the image processing apparatus 10. The remote operation is an indirect input operation that is performed with respect to the user interface of the image processing apparatus 10 that is concurrently displayed on the user terminal 30, by a user who operates the user terminal 30 remotely connected to the image processing apparatus 10. Hereinafter, the user who remotely operates the image processing apparatus 10 is referred to as a “first user”, and the user who directly operates the image processing apparatus 10 is referred to as a “second user”.

Further, the image processing apparatus 10 acquires various information transmitted from the user terminal 30, and performs various processes. Further, the image processing apparatus 10 transmits various information to the user terminal 30. For example, the image processing apparatus 10 receives a job execution request by a remote operation from the first user, and acquires input information thereof. The “job” is a unit indicating a predetermined process (for example, printing or reading) that is executed by the image processing apparatus 10.

Upon receiving a job execution request from the first user and determining that the second user is performing a direct operation with respect to the image processing apparatus 10, the image processing apparatus 10 inquires of the second user whether to permit the execution of the job being requested to be executed by the first user. As an example of the method of inquiring of the second user whether to permit the execution of the job being requested to be executed by the first user, there is a method by which a button for allowing the second user to select whether to permit the execution of the job being requested to be executed by the first user is displayed on the user interface of the image processing apparatus 10. A method by which the image processing apparatus 10 determines whether the second user is performing a direct operation with respect to the image processing apparatus 10 will be described later.

If the execution of the job being requested to be executed by the first user is permitted as a response of the second user to the inquiry from the image processing apparatus 10, the image processing apparatus 10 executes the job being requested to be executed by the first user. For example, as a method of inquiring of the second user whether to permit the execution of the job being requested to be executed by the first user, it is assumed that a button for allowing the second user to select whether to permit the execution of the job being requested to be executed by the first user is displayed on the user interface of the image processing apparatus 10. In this case, when the button for permitting the execution of the job being requested to be executed by the first user is pressed, the image processing apparatus 10 executes the job being requested to be executed by the first user. The details of the configuration and processing of the image processing apparatus 10 will be described later. User Terminal

The user terminal 30 is an information processing apparatus such as a smartphone, a tablet terminal, or a personal computer that is operated by a user who utilizes the information processing system 1. Application software that enables a remote operation of the image processing apparatus 10 is installed in the user terminal 30.

The user terminal 30 acquires various information transmitted from the image processing apparatus 10, and performs various processes. Further, the user terminal 30 transmits various information to the image processing apparatus 10. For example, the user terminal 30 concurrently displays the user interface of the remotely connected image processing apparatus 10. Further, the user terminal 30 receives an input operation with respect to the user interface being concurrently displayed, and acquires the input information thereof.

For example, when an input operation for causing the image processing apparatus 10 to execute a job is performed as an input operation with respect to the user interface being concurrently displayed, the user terminal 30 receives the input operation as a “job execution request” and acquires the input information thereof. Then, the user terminal 30 transmits the acquired input information to the image processing apparatus 10. The details of the configuration and processing of the user terminal 30 will be described later.

The configuration of the information processing system 1 described above is an example, and the information processing system 1 as a whole need only have the functionality to implement the processes described above. Thus, some or all of the functions for implementing the above-described processing may be shared in the information processing system 1 or may cooperate with each other. That is, some or all of the functions of the user terminal 30 may be implemented as functions of the image processing apparatus 10, and some or all of the functions of the image processing apparatus 10 may be implemented as functions of the user terminal 30. Furthermore, some or all of the functions of the user terminal 30 and the image processing apparatus 10 of which the information processing system 1 is composed may be transferred to another server or the like (not illustrated). In this way, the processing in the information processing system 1 as a whole is facilitated, and it also becomes possible to complement processing with each other.

### Hardware Configuration of Image Processing Apparatus

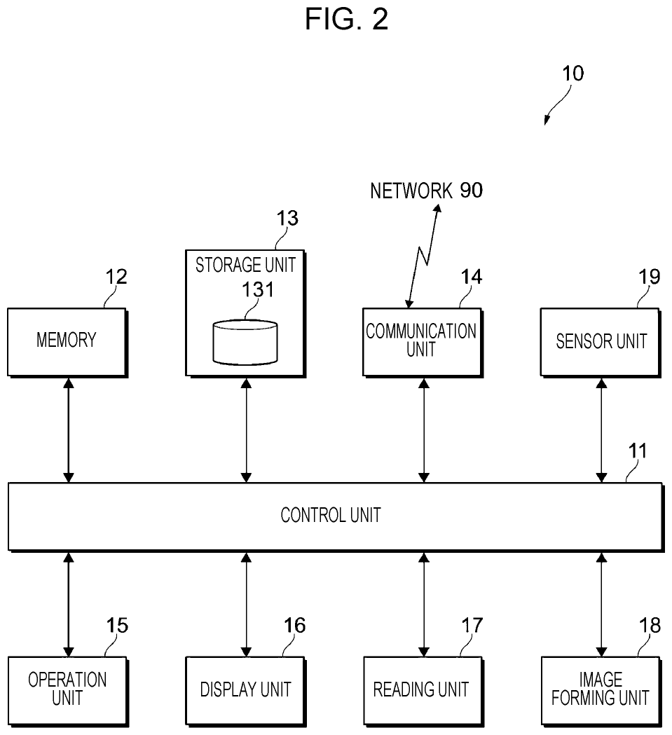

FIG. 2 is a diagram of an example of a hardware configuration of the image processing apparatus 10.

The image processing apparatus 10 includes a control unit 11, a memory 12, a storage unit 13, a communication unit 14, an operation unit 15, a display unit 16, a reading unit 17, an image forming unit 18, and a sensor unit 19. These units are connected to each other via a data bus, an address bus, a Peripheral Component Interconnect (PCI) bus, or the like.

The control unit 11 is a processor that controls the functions of the image processing apparatus 10 through execution of various software, such as an operating system (OS) (basic software) and application software. The control unit 11 is composed of, for example, a central processing unit (CPU). The memory 12 is a storage area for storing various software, data used for executing the software, and the like, and is used as a work area for computations. The memory 12 is composed of, for example, a random access memory (RAM).

The storage unit 13 is a storage area that stores input data to various software, output data from various software, and the like. The storage unit 13 is composed of, for example, a hard disk drive (HDD), a solid state drive (SSD), or a semiconductor memory, or the like that is used to store programs, various setting data, and the like. The storage unit 13 includes, as a database (DB) for storing various information, a user DB 131 in which user-related information (hereinafter referred to as “user information”) is stored.

The communication unit 14 transmits and receives data to and from the user terminal 30 and the outside via the network 90. The operation unit 15 is composed of, for example, a software keyboard, a mechanical button, or a switch, and receives an input operation. The operation unit 15 also includes touch sensors that constitute a touch panel integrally with the display unit 16. The display unit 16 is composed of, for example, a liquid crystal display or an organic electro luminescence (EL) display that is used for displaying information. The display unit 16 displays data, such as an image or text.

The reading unit 17 reads an image recorded on a medium, such as a sheet as a recording medium (for example, a document of a paper medium). The reading unit 17 is composed of, for example, a CCD-type scanner in which reflected light of light shone on a document from a light source is reduced in size by a lens and received by a charge coupled device (CCD), or a CIS-type scanner in which reflected light of light sequentially shone on a document from a light-emitting diode (LED) light source is received by a contact image sensor (CIS).

The image forming unit 18 forms an image to be printed on a printing surface of a sheet as a recording medium by, for example, an electrophotographic method or an inkjet method. These units are connected to each other via a data bus, an address bus, a PCI bus, or the like. The sensor unit 19 is composed of various sensors, such as an ambient light sensor, a proximity sensor, an optical sensor for light detection and ranging (LiDAR) or the like, or an acceleration sensor, and detects the use of the image processing apparatus 10 by the second user.

### Hardware Configuration of User Terminal

The hardware configuration of the user terminal 30 is similar to the hardware configuration of the image processing apparatus 10 illustrated in FIG. 2, except for the reading unit 17, the image forming unit 18, and the sensor unit 19. That is, the user terminal 30 includes a control unit, a memory, a storage unit, a communication unit, an operation unit, and a display unit having functions similar to those of the control unit 11, the memory 12, the storage unit 13, the communication unit 14, the operation unit 15, and the display unit 16 in FIG. 2, respectively. Thus, illustration and description the units are omitted.

### Functional Configuration of Control Unit of Image Processing Apparatus

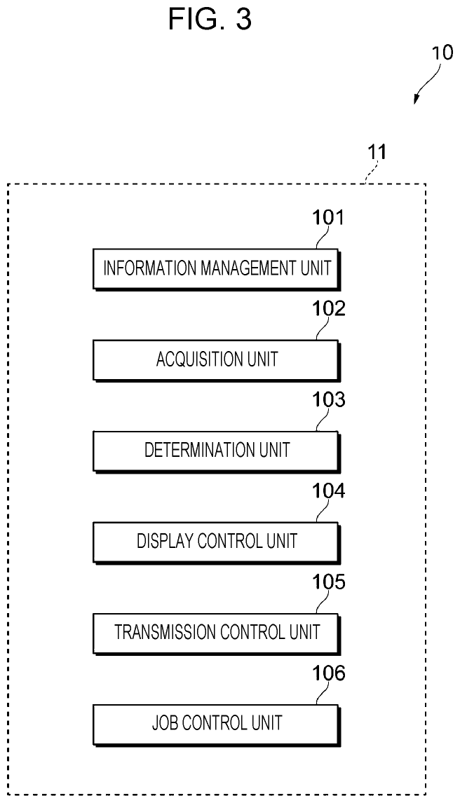

FIG. 3 is a diagram of an example of a functional configuration of the control unit 11 of the image processing apparatus 10.

In the control unit 11 of the image processing apparatus 10, an information management unit 101, an acquisition unit 102, a determination unit 103, a display control unit 104, a transmission control unit 105, and a job control unit 106 function.

The information management unit 101 stores and manages various information in the database of the storage unit 13 (see FIG. 2). For example, the information management unit 101 stores and manages user information in the user DB 131. The user information managed by the information management unit 101 includes identification information (for example, a user ID or biological information) capable of uniquely identifying the user, a user name, authentication information for using the image processing apparatus 10, and a past record of permission or rejection of job execution requests by a remote operation.

The acquisition unit 102 acquires various information. For example, the acquisition unit 102 acquires input information whose input has been accepted by the operation unit 15 (see FIG. 2) as a direct operation with respect to the user interface displayed on the display unit 16. In this case, the input information acquired by the acquisition unit 102 includes, for example, input information input as a response to an inquiry about whether to permit the execution of a job being requested to be executed by the first user. The acquisition unit 102 also acquires various information transmitted from the user terminal 30. The information transmitted from the user terminal 30 includes, for example, a job execution request.

The determination unit 103 determines whether a direct operation is being performed with respect to the image processing apparatus 10 by the second user. For example, the determination unit 103 determines whether the second user is performing a direct operation with respect to the image processing apparatus 10 based on sensing information obtained from the sensor unit 19 (see FIG. 2). Examples of the sensing information obtained from the sensor unit 19 include information indicating whether the second user performing a direct operation with respect to the image processing apparatus 10 has been detected, and information indicating whether an object that is being input to or output from the image processing apparatus 10 has been detected. The object that is being input to or output from the image processing apparatus 10 is, for example, a document or a printed sheet.

Further, for example, the determination unit 103 determines whether a direct operation by the second user with respect to the image processing apparatus 10 is being performed, based on the authentication information for using the image processing apparatus 10. Examples of the authentication information for using the image processing apparatus 10 include information indicating the presence or absence of a user who is authenticated to use the image processing apparatus 10. The information indicating the presence or absence of a user who is authenticated to use the image processing apparatus 10 is, for example, information indicating whether there is a user who has logged in to the image processing apparatus 10.

The display control unit 104 performs control to cause the display unit 16 (see FIG. 2) to display various information. For example, the display control unit 104 performs control to cause the display unit 16 to display the user interface. The user interface displayed on the display unit 16 includes, for example, information indicating that a job execution request has been made by the first user, and information for providing a response to an inquiry about whether to permit the execution of the job being requested to be executed by the first user.

Further, the display control unit 104 performs control to cause the display unit of the user terminal 30 to display various information. For example, the display control unit 104 performs control to cause the display unit of the user terminal 30 to concurrently display the user interface being displayed on the display unit 16. Furthermore, the display control unit 104 performs control so that predetermined information among the various information included in the user interface displayed on the display unit 16 is not concurrently displayed on the display unit of the user terminal 30. In this case, the “predetermined information” includes, for example, information for providing a response to an inquiry about whether to permit the execution of a job being requested to be executed by the first user.

In addition, the display control unit 104 performs control to cause the display unit of the user terminal 30 to display information indicating whether the job being requested to be executed by the first user can be executed. In this case, the display control unit 104 determines the contents to be displayed in accordance with the contents of the response from the second user to the inquiry about whether to permit the execution of the job being requested to be executed by the first user.

Specifically, if the contents of the response from the second user permit the execution of the job being requested to be executed by the first user, the display control unit 104 performs control to cause the display unit of the user terminal 30 to display that the job can be executed. In this case, the display control unit 104 may perform control such that the information for instructing the execution of the job being requested to be executed by the first user is displayed only on the display unit 16 of the image processing apparatus 10. The information for instructing the execution of the job being requested to be executed by the first user includes, for example, a button for instructing the execution of the job (hereinafter, referred to as an “execution button”).

On the other hand, if the contents of the response from the second user do not permit the execution of the job being requested to be executed by the first user, the display control unit 104 performs control to cause the display unit of the user terminal 30 to display that the job being requested to be executed by the first user cannot be executed.

The transmission control unit 105 performs control to cause various information to be transmitted via the communication unit 14 (see FIG. 2). For example, the transmission control unit 105 performs control to cause various information to be transmitted to the user terminal 30. The information transmitted to the user terminal 30 includes, for example, control information for causing the display unit of the user terminal 30 to display various information.

The control information transmitted to the user terminal 30 includes, for example, control information for causing the user interface being displayed on the display unit 16 of the image processing apparatus 10 to be concurrently displayed on the display unit of the user terminal 30; control information for preventing predetermined information among the various information included in the user interface from being concurrently displayed on the display unit of the user terminal 30; and control information for displaying information indicating whether the job being requested to be executed by the first user can be executed.

The job control unit 106 performs control to cause the image processing apparatus 10 to execute a job, and control not to cause the image processing apparatus 10 to execute a job. For example, if the contents of the response from the second user to the inquiry permit the execution of the job being requested to be executed by the first user, the job control unit 106 performs control to cause the job to be executed. Furthermore, for example, if the contents of the response from the second user to the inquiry do not permit the execution of the job being requested to be executed by the first user, the job control unit 106 performs control not to cause the job to be executed.

After the information for providing a response to the inquiry about whether to permit the execution of the job being requested to be executed by the first user is displayed on the display unit 16, if no response is provided within a predetermined time, the job control unit 106 determines rejection of the job being requested to be executed by the first user, and performs control so that the job being requested to be executed by the first user is not executed.

### Functional Configuration of Control Unit of User Terminal

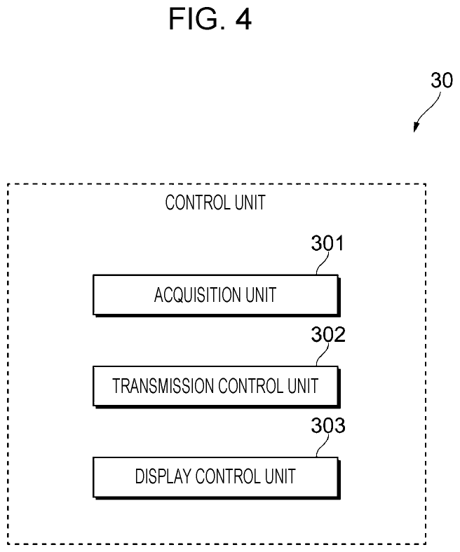

FIG. 4 is a diagram of an example of a functional configuration of the control unit of the user terminal 30.

In the control unit of the user terminal 30, an acquisition unit 301, a transmission control unit 302, and a display control unit 303 function.

The acquisition unit 301 acquires various information. For example, the acquisition unit 301 acquires input information whose input has been accepted by the operation unit of the user terminal 30. Furthermore, for example, the acquisition unit 301 acquires various information transmitted from the image processing apparatus 10. Examples of the information transmitted from the image processing apparatus 10 include control information for causing the display unit of the user terminal 30 to display various information.

The transmission control unit 302 performs control to cause various information to be transmitted via the communication unit. For example, the transmission control unit 302 performs control for transmitting various information to the image processing apparatus 10. Examples of the information to be transmitted to the image processing apparatus 10 include the input information acquired by the acquisition unit 301. Examples of the input information acquired by the acquisition unit 301 include a job execution request.

The display control unit 303 performs control to cause the display unit to display various information. For example, the display control unit 303 performs control to cause the user interface being displayed on the display unit 16 (see FIG. 2) of the image processing apparatus 10 to be concurrently displayed on the display unit of the user terminal 30. Further, the display control unit 303 performs control to cause the display unit to display information indicating whether the job being requested to be executed by the first user can be executed. Specifically, the display control unit 303 causes the display unit to display the above information based on the control information acquired by the acquisition unit 301.

### Process Flow

### Flow of Process in Image Processing Apparatus

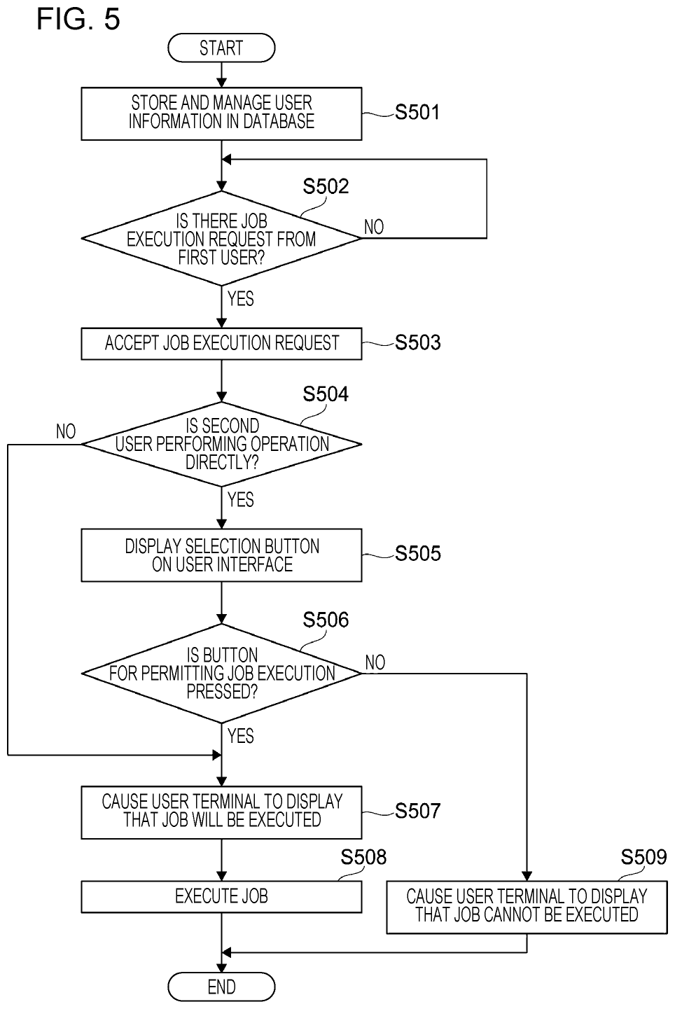

FIG. 5 is a flowchart of the flow of a process in the image processing apparatus 10.

The image processing apparatus 10 stores and manages user information in the database (step 501). To be specific, the image processing apparatus 10 stores and manages the user information in the user DB 131 of the storage unit 13 (see FIG. 2).

Next, if there is a job execution request from the first user (YES in step 502), the image processing apparatus 10 receives the job execution request (step 503). If the image processing apparatus 10 determines that the second user is performing a direct operation (YES in step 504), the image processing apparatus 10 displays, on the user interface, selection buttons for allowing the second user to select whether to permit the execution of the job being requested by the first user (step 505).

On the other hand, if the second user is not performing a direct operation with respect to the image processing apparatus 10 (NO in step 504), the image processing apparatus 10 causes the user terminal 30 to display that the job being requested to be executed will be executed (step 507), executes the job (step 508), and ends the process (END). If there is no job execution request from the first user (NO in step 502), the image processing apparatus 10 repeats the determination processing in step 502 until there is a job execution request from the first user.

Thereafter, if the button for permitting the execution of the job among the selection buttons displayed on the user interface in step 505 is pressed (YES in step 506), the image processing apparatus 10 causes the user terminal 30 to display that the job being requested to be executed can be executed (step 507), executes the job (step 508), and ends the process (END). On the other hand, if the button that does not permit the execution of the job among the selection buttons displayed on the user interface in step 505 is pressed (NO in step 506), the image processing apparatus 10 causes the user terminal 30 to display that the job being requested to be executed cannot be executed (step 509), and ends the process (END).

### SPECIFIC EXAMPLES

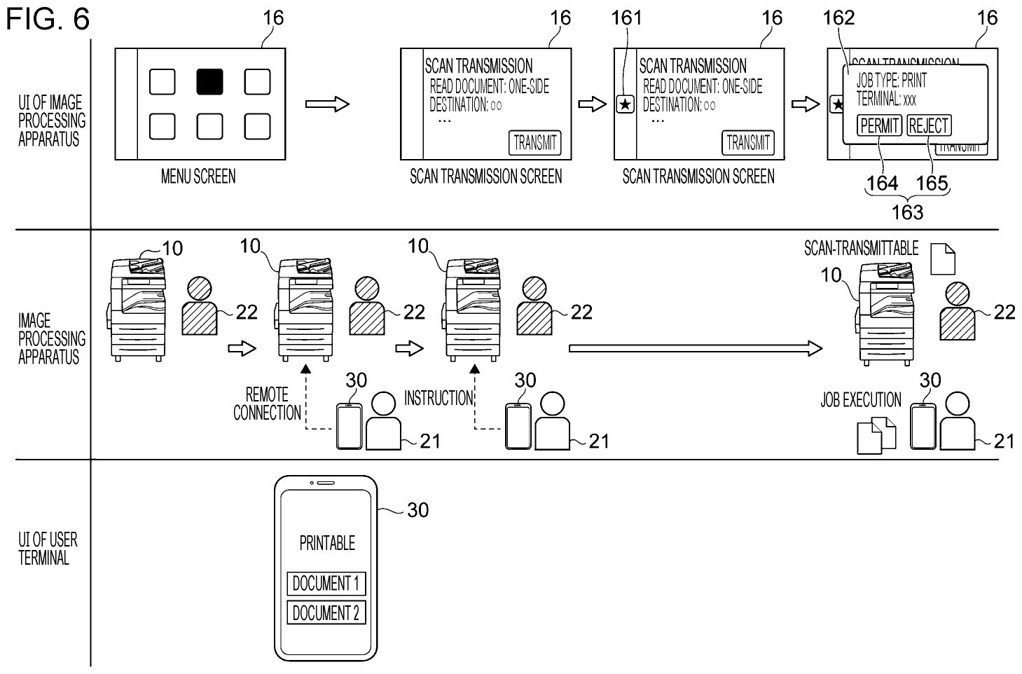

FIG. 6 is a diagram illustrating the flow of the states of the image processing apparatus 10 and the user terminal 30. In FIG. 6, it is assumed that time flows from the left side to the right side.

As illustrated in FIG. 6, when a second user 22 approaches the image processing apparatus 10, a menu screen is displayed on the display unit 16 of the image processing apparatus 10. Here, if the second user 22 makes, on the menu screen, a setting for executing “Scan transmission” in which a document reading process and a transmission process for the corresponding read data are performed, a screen for scan transmission is displayed on the display unit 16.

Here, it is assumed that a first user 21 is performing an operation for instructing the user terminal 30 remotely connected to the image processing apparatus 10 to execute a “Printing” job for performing a document printing process. In this case, the user terminal 30 displays a screen that allows the user to designate a document file to be printed, together with a message “Printable”, as illustrated in FIG. 6, for example.

Here, if the first user 21 performs an operation on the user terminal 30 to instruct the execution of the “Printing” job by the image processing apparatus 10, a button 161 is displayed in a part of the scan transmission screen displayed on the display unit 16 of the image processing apparatus 10, as information indicating that the job execution request has been made by the first user 21. As the button 161 is displayed in a part of the scan transmission screen, the second user 22 learns that a job execution request has been made by the first user 21.

If the second user 22 who has learned that the job execution request has been made by the first user 21 presses the button 161, a pop-up screen 162 including selection buttons 163 for selecting whether to permit the execution of the job being requested to be executed by the first user 21 is displayed. Here, the second user 22 selects whether to permit the execution of the job being requested to be executed by the first user 21, in consideration of the trade-off with a work that the second user 22 is performing (work for causing the image processing apparatus 10 to execute “Scan transmission”).

For example, it is assumed here that the specifications of the image processing apparatus 10 are such that the process of “Scan transmission” and the process of “Printing” can be executed in parallel. In this case, if the second user 22 presses a button 164 marked with “Permit” among the selection buttons 163 displayed on the pop-up screen 162, the “Printing” job being requested to be executed by the first user 21 is executed. At the same time, an indication that the “Printing” job being requested to be executed by the first user 21 will be executed is displayed on the display unit of the user terminal 30. Further, when the process of “Printing” is completed, a corresponding indication is displayed on the display unit of the user terminal 30.

On the other hand, if the second user 22 presses a button 165 marked with “Reject” among the selection buttons 163 displayed on the pop-up screen 162, the display unit of the user terminal 30 displays that the “Printing” job cannot be executed because the second user is performing a direct operation with respect to the image processing apparatus 10.

### Second Exemplary Embodiment

### Hardware Configuration of Image Processing Apparatus

The hardware configuration of the image processing apparatus 10 and the functional configuration of the control unit 11 according to a second exemplary embodiment are basically the same as the hardware configuration of the image processing apparatus 10 and the functional configuration of the control unit 11 respectively illustrated in FIGS. 2 and 3 described above. In the above-described first exemplary embodiment, when the image processing apparatus 10 receives a job execution request from the first user, if the image processing apparatus 10 determines that the second user is performing a direct operation with respect to the apparatus, the image processing apparatus 10 inquires of the second user whether to permit the execution of the job being requested by the first user. In contrast, in the second exemplary embodiment, no inquiry is made to the second user directly operating the image processing apparatus 10.

That is, in the image processing apparatus 10 according to the second exemplary embodiment, when a request for the execution of a job is made to the image processing apparatus 10 by a remote operation performed by the first user, if a direct operation is being performed with respect to the image processing apparatus 10 by the second user, the image processing apparatus 10 displays the execution button on the user interface of the image processing apparatus 10 if a predetermined condition is satisfied. Here, if the first user who remotely operates the image processing apparatus 10 presses the execution button displayed on the image processing apparatus 10 as a direct operation with respect to the image processing apparatus 10, the job being requested to be executed by the first user is executed.

At this time, on the user terminal 30 of the first user, the user interface of the image processing apparatus 10 is concurrently displayed but the execution button is controlled not to be concurrently displayed. This is based on the requirement for information security that does not permit execution of a job by a remote operation in the absence of a user in front of the image processing apparatus 10.

Examples of the condition for causing the execution button to be displayed on the user interface of the image processing apparatus 10 include, for example, a condition that the direct operation by the second user has ceased to be performed after the execution request is made by the first user and before the image processing apparatus 10 receives the execution request, and a condition that there is a past record of permission obtained for the job execution request.

If the condition that the direct operation by the second user has ceased to be performed after the job execution request is made by the first user and before the image processing apparatus 10 receives the job execution request is satisfied, the image processing apparatus 10 displays the execution button after the job execution request from the first user is received. Further, if the condition that there is a past record of permission obtained for the job execution request is satisfied, the image processing apparatus 10 immediately displays the execution button.

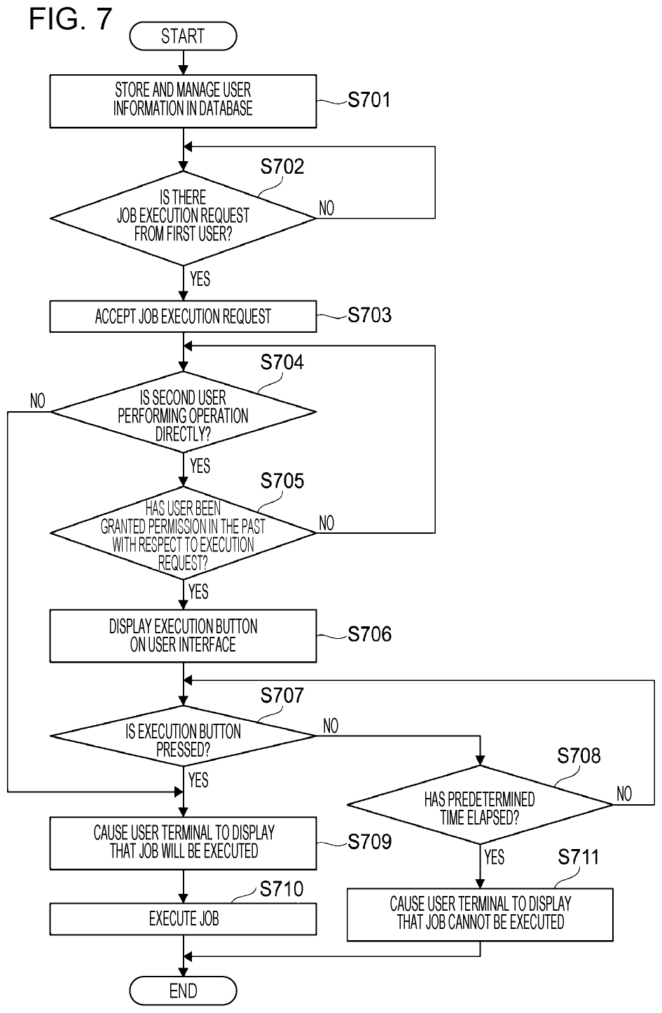

FIG. 7 is a flowchart of the flow of the process in the image processing apparatus 10 according to the second exemplary embodiment. In the process in the image processing apparatus 10 according to the second exemplary embodiment, the flow of processing from step 701 to step 703 is the same as the processing from step 501 to step 503 of the first exemplary embodiment described above. Thus, a description of the processing is omitted.

If the image processing apparatus 10 determines that the second user is performing a direct operation (YES in step 704), the process proceeds to determination processing in step 705. On the other hand, if it is determined that the second user is not performing a direct operation with respect to the image processing apparatus 10 (NO in step 704), the image processing apparatus 10 causes the user terminal 30 to display that the job being requested to be executed by the first user will be executed (step 709), executes the job (step 710), and ends the process (END).

If the first user who has made the job execution request is a user who has a past record of permission obtained for the job execution request (YES in step 705), the image processing apparatus 10 displays the execution button on the user interface (step 706). On the other hand, if the first user who has made the job execution request is a user who does not have a past record of permission obtained for the job execution request (NO in step 705), the process returns to the determination process in step 704.

When the execution button displayed on the user interface is pressed (YES in step 707), the image processing apparatus 10 causes the user terminal 30 to display that the job being requested to be executed by the first user will be executed (step 709), executes the job (step 710), and ends the process (END). On the other hand, when the execution button is not pressed (NO in step 707), the process proceeds to determination processing in step 708.

If a predetermined time elapses without the execution button being pressed (YES in step 708), the image processing apparatus 10 causes the user terminal 30 to display that the job being requested to be executed by the first user cannot be executed (step 711), and ends the process (END). On the other hand, if the predetermined time has not elapsed (NO in step 708), the process returns to the determination processing in step 707.

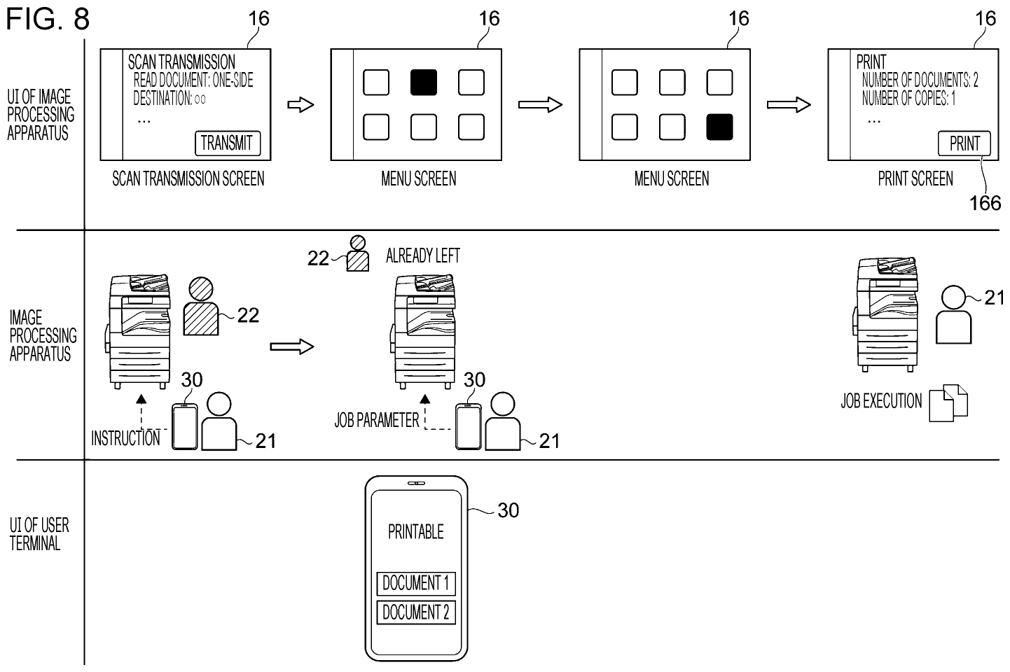

FIG. 8 is a diagram illustrating the flow of the states of the image processing apparatus 10 and the user terminal 30. In FIG. 8, it is assumed that time flows from the left side to the right side.

When the second user 22 approaches the image processing apparatus 10 and makes a setting for executing “Scan transmission” in which a document reading process and a transmission process for the corresponding read data are performed, a screen for scan transmission is displayed on the display unit 16. Here, it is assumed that the first user 21 is performing an operation for instructing the user terminal 30 remotely connected to the image processing apparatus 10 to execute a “Printing” job for performing a document printing process. In this case, the user terminal 30 displays a message “Printable” and a screen that allows the user to designate a document file to be printed, as illustrated in FIG. 8, for example.

Here, it is assumed that the first user 21 has performed, on the user terminal 30, an operation for instructing the execution the job of “Printing” by the image processing apparatus 10. In this case, in the above-described first exemplary embodiment as illustrated in FIG. 6, the button 161 is displayed in a part of the scan transmission screen displayed on the display unit 16 of the image processing apparatus 10, as information indicating that the job execution request has been made by the first user 21. However, if the second user 22 who has been in front of the image processing apparatus 10 has already left when the job execution request is made by the first user 21, the following process is performed.

Specifically, the image processing apparatus 10 does not display the button 161 of FIG. 6 on the display unit 16. That is, as illustrated in FIG. 8, the image processing apparatus 10 does not display, on the display unit 16, the information indicating that a job execution request has been made by the first user 21. In this case, the image processing apparatus 10 acquires job parameters from the user terminal 30 remotely connected to the image processing apparatus 10. The job parameters are information required for execution of the “Printing” job by the image processing apparatus 10.

The display unit 16 of the image processing apparatus 10 that has acquired the job parameters displays information of at least some of the job parameters and information for instructing the execution of the process of “Printing”. Here, the information for instructing the execution of the process of “Printing” is, for example, the display of a button 166 indicating “Print”, as illustrated in FIG. 8. The first user 21 approaches the image processing apparatus 10 and presses the button 166 displayed on the display unit 16 of the image processing apparatus 10, thereby instructing the execution of the process of “Printing”. Then, the image processing apparatus 10 starts the process of “Printing”.

### OTHER EXEMPLARY EMBODIMENTS

Although the exemplary embodiments have been described above, the present disclosure is not limited to the above-described exemplary embodiments. Furthermore, the effects of the present disclosure are also not limited to those described in the above-described exemplary embodiments. For example, the configuration of the information processing system 1 illustrated in FIG. 1 and the hardware configuration of the image processing apparatus 10 illustrated in FIG. 2 are both merely examples for achieving the objects of the present disclosure and are not particularly limited. Furthermore, the functional configuration of the image processing apparatus 10 illustrated in FIG. 3 and the functional configuration of the user terminal 30 illustrated in FIG. 4 are also merely examples and are not particularly limited. It is sufficient that the information processing system 1 of FIG. 1 is provided with functionality capable of executing the above-described processes as a whole, and the functional configuration for implementing the functionality is not limited to the examples of FIGS. 3 and 4.

Furthermore, the order of the steps of the process in the image processing apparatus 10 illustrated in each of FIGS. 5 and 7 is also merely an example and is not particularly limited. The process may be performed not only in a time-series manner according to the order of the illustrated steps, but also in parallel or individually without being necessarily performed in a time-series manner. The specific examples illustrated in FIGS. 6 and 8 are also merely examples, and are not particularly limited.

For example, in the specific example illustrated in FIG. 6, when the first user 21 performs an operation on the user terminal 30 to instruct the execution of the “Printing” job by the image processing apparatus 10, the button 161 is displayed in a part of the scan transmission screen displayed on the display unit 16 of the image processing apparatus 10, as information indicating that the job execution request has been made by the first user 21. As a result, the second user 22 learns that the job execution request has been made by the first user 21 when the button 161 is displayed in a part of the scan transmission screen.

However, the information displayed on the display unit 16 of the image processing apparatus 10 is not limited to the information indicating that the job execution request has been made by the first user 21. Other information for assisting various paperwork of each of the first user 21 and the second user 22 who share one image processing apparatus 10 may be displayed. For example, information may be displayed indicating whether a job that the second user is causing the image processing apparatus 10 to execute and a job being requested to be executed by the first user can be executed in parallel. For example, when the job that the second user 22 is causing the image processing apparatus 10 to execute is “Scan and transmit”, a message “Process of printing of A, B, and C can be executed in parallel” may be displayed on the display unit 16 of the image processing apparatus 10.

The above-described second exemplary embodiment is configured such that, as illustrated in FIG. 7, if a predetermined time elapses without the execution button being pressed, the user terminal 30 is caused to display that the job being requested to be executed by the first user cannot be executed, and the process is terminated. However, this is not a limitation. For example, a configuration may be adopted in which execution of the job being requested to be executed by the first user is automatically permitted if a predetermined time elapses without the execution button being pressed.

### Appendix

(((1)))

An information processing apparatus comprising:

one or more processors configured to:
when a request for execution of a job is made to the information processing apparatus by a remote operation from a remote terminal of a first user, in a case where a direct operation is being performed by a second user with respect to the information processing apparatus, inquire of the second user whether to permit the execution of the job; and
cause the job to be executed in a case where the execution of the job is permitted as a response to the inquiry.

(((2)))

The information processing system according to (((1))), wherein the one or more processors are configured to cause the information processing apparatus to display, as the inquiry, information indicating that the execution request has been made and information for providing a response to the inquiry.

(((3)))

The information processing system according to (((2))), wherein the one or more processors are configured not to cause the remote terminal to display the information for providing a response to the inquiry.

(((4)))

The information processing system according to (((3))), wherein the one or more processors are configured to cause the remote terminal to display, in accordance with contents of the response to the inquiry, information indicating whether the job can be executed.

(((5)))

The information processing system according to (((4))), wherein in a case where the job can be executed, the one or more processors cause only the information processing apparatus to display information for instructing the execution of the job.

((6)

The information processing system according to any one of (((2)) to (((5))), wherein the one or more processors are configured to determine to reject the job in a case where the response is not provided within a predetermined time after the information for providing a response is displayed on the information processing apparatus.

(((7)))

The information processing system according to any one of (((1))) to (((6))), wherein the one or more processors are configured to determine whether the direct operation is being performed based on at least one of sensing information of a sensor that detects use of the information processing apparatus and authentication information for using the information processing apparatus.

(((8)))

The information processing system according to (((7))), wherein the one or more processors are configured to determine whether the direct operation is being performed based on, as the sensing information, information indicating whether the sensor has detected at least one of a user performing the direct operation on the information processing apparatus and an object that is being input to or output from the information processing apparatus.

(((9)))

The information processing system according to (((7))), wherein the one or more processors are configured to determine whether the direct operation is being performed based on, as the authentication information, information indicating a presence or absence of a user who is authenticated to use the information processing apparatus.

(((10)))

An information processing system comprising:

one or more processors configured to:
when a request for execution of a job is made to an information processing apparatus by a remote operation by a first user, in a case where a direct operation is being performed by a second user with respect to the information processing apparatus, cause the information processing apparatus to display information for instructing the execution of the job if a predetermined condition is satisfied; and
cause the job to be executed in response to an instruction by the first user to execute the job.

(((11)))

The information processing system according to (((10))), wherein the one or more processors are configured to cause the information processing apparatus to display the information for instructing the execution of the job after receiving the execution request in a case where, as the predetermined condition, the direct operation has ceased to be performed after the execution request is made and before the information processing apparatus receives the execution request.

(((12)))

The information processing system according to (((10))), wherein the one or more processors are configured to cause the information processing apparatus to display the information for instructing the execution of the job in a case where, as the predetermined condition, there is a past record of permission obtained for the execution request by the remote operation by the first user.

(((13)))

A program causing a computer to execute a process comprising:

when a request for execution of a job is made to an information processing apparatus by a remote operation by a first user, in a case where a second user is performing a direct operation with respect to the information processing apparatus, inquiring of the second user whether to permit the execution of the job; and

causing the job to be executed in a case where the execution of the job is permitted as a response to the inquiry.

(((14)))

A program causing a computer to execute a process comprising:

when a request for execution of a job is made to an information processing apparatus by a remote operation by a first user, in a case where a direct operation is being performed by a second user with respect to the information processing apparatus, causing the information processing apparatus to display information for instructing the execution of the job if a predetermined condition is satisfied; and

causing the job to be executed in response to an instruction by the first user to execute the job.

What is claimed is:

1. An information processing apparatus comprising:
one or more processors configured to:
when a request for execution of a job is made to the information processing apparatus by a remote operation from a remote terminal of a first user, in a case where a direct operation is being performed by a second user with respect to the information processing apparatus, inquire of the second user whether to permit the execution of the job; and
cause the job to be executed in a case where the execution of the job is permitted as a response to the inquiry.

2. The information processing system according to claim 1, wherein the one or more processors are configured to cause the information processing apparatus to display, as the inquiry, information indicating that the execution request has been made and information for providing a response to the inquiry.

3. The information processing system according to claim 2, wherein the one or more processors are configured not to cause the remote terminal to display the information for providing a response to the inquiry.

4. The information processing system according to claim 3, wherein the one or more processors are configured to cause the remote terminal to display, in accordance with contents of the response to the inquiry, information indicating whether the job can be executed.

5. The information processing system according to claim 4, wherein in a case where the job can be executed, the one or more processors are configured to cause only the information processing apparatus to display information for instructing the execution of the job.

6. The information processing system according to claim 2, wherein the one or more processors are configured to determine to reject the job in a case where the response is not provided within a predetermined time after the information for providing a response is displayed on the information processing apparatus.

7. The information processing system according to claim 1, wherein the one or more processors are configured to determine whether the direct operation is being performed based on at least one of sensing information of a sensor that detects use of the information processing apparatus and authentication information for using the information processing apparatus.

8. The information processing system according to claim 7, wherein the one or more processors are configured to determine whether the direct operation is being performed based on, as the sensing information, information indicating whether the sensor has detected at least one of a user performing the direct operation on the information processing apparatus and an object that is being input to or output from the information processing apparatus.

9. The information processing system according to claim 7, wherein the one or more processors are configured to determine whether the direct operation is being performed based on, as the authentication information, information indicating a presence or absence of a user who is authenticated to use the information processing apparatus.

10. An information processing system comprising:
one or more processors configured to:
when a request for execution of a job is made to an information processing apparatus by a remote operation by a first user, in a case where a direct operation is being performed by a second user with respect to the information processing apparatus, cause the information processing apparatus to display information for instructing the execution of the job if a predetermined condition is satisfied; and
cause the job to be executed in response to an instruction by the first user to execute the job.

11. The information processing system according to claim 10, wherein the one or more processors are configured to cause the information processing apparatus to display the information for instructing the execution of the job after receiving the execution request in a case where, as the predetermined condition, the direct operation has ceased to be performed after the execution request is made and before the information processing apparatus receives the execution request.

12. The information processing system according to claim 10, wherein the one or more processors are configured to cause the information processing apparatus to display the information for instructing the execution of the job in a case where, as the predetermined condition, there is a past record of permission obtained for the execution request by the remote operation by the first user.

13. A non-transitory computer readable medium storing a program causing a computer to execute a process comprising:
when a request for execution of a job is made to an information processing apparatus by a remote operation by a first user, in a case where a second user is performing a direct operation with respect to the information processing apparatus, inquiring of the second user whether to permit the execution of the job; and
causing the job to be executed in a case where the execution of the job is permitted as a response to the inquiry.

14. A non-transitory computer readable medium storing a program causing a computer to execute a process comprising:
when a request for execution of a job is made to an information processing apparatus by a remote operation by a first user, in a case where a direct operation is being performed by a second user with respect to the information processing apparatus, causing the information processing apparatus to display information for instructing the execution of the job if a predetermined condition is satisfied; and
causing the job to be executed in response to an instruction by the first user to execute the job.
